(19) United States
(12) Patent Application Publication
(10) Pub. No.: US 2020/0402004 A1
(43) Pub. Date: Dec. 24, 2020

(54) VISIT-TIME-DETERMINING DEVICE

(71) Applicant: NTT DOCOMO, INC., Chiyoda-ku (JP)

(72) Inventors: Tsukasa DEMIZU, Chiyoda-ku (JP); Haruka KIKUCHI, Chiyoda-ku (JP); Yusuke FUKAZAWA, Chiyoda-ku (JP)

(73) Assignee: NTT DOCOMO, INC., Chiyoda-ku (JP)

(21) Appl. No.: 16/975,553

(22) PCT Filed: Feb. 15, 2019
(86) PCT No.: PCT/JP2019/005664

§ 371 Date: Aug. 25, 2020

(30) Foreign Application Priority Data
Feb. 27, 2018 (JP) 2018-033401

(51) Int. Cl. G06Q 10/08; G06Q 10/04

(52) U.S. Cl. CPC G06Q 10/08355; G06Q 10/047; G06Q 10/0838

(57) ABSTRACT

The visit-time-determining device is a device that determines a visit time for a plurality of visit destinations, and the visit-time-determining device includes a visit time determination unit configured to determine a visit time for each of the visit destinations, a clustering unit configured to cluster visit destinations on the basis of geographical positions of the visit destinations at each of the determined visit times, and a re-determination visit destination selection unit configured to select a visit destination for which the visit time is to be re-determined from the plurality of visit destinations on the basis of a result of the clustering, wherein the visit time determination unit re-determines the visit time of the visit destination selected by the re-determination visit destination selection unit from times other than determined visit time.

### TECHNICAL FIELD

The present invention relates to a visit-time-determining device that determines a visit time for a plurality of visit destinations.

### BACKGROUND ART

Conventionally, generation of a delivery route for performing efficient delivery of goods has been proposed (for example, refer to Patent Literature 1).

### CITATION LIST

### Patent Literature

[Patent Literature 1] Japanese Unexamined Patent Publication No. 2010-79808

### SUMMARY OF INVENTION

### Technical Problem

When goods are delivered to individuals, if the residents of a delivery destination are absent, delivery cannot be performed and re-delivery or the like is required. Therefore, for example, even if the delivery destination is visited so that the moving distance (the traveling distance) is minimized, a resident may not always be at home and efficient delivery may not be performed. On the other hand, in consideration of a possibility of a resident being at home, for example, if a visit is intended to be performed only at the time of the highest possibility of the resident being at home, the number of deliveries may increase depending on a time period, which may pose a risk of an excessive load being imposed on a delivery person or of a moving distance increasing.

An embodiment of the present invention has been made in view of the situations described above, and an object thereof is to provide a visit-time-determining device that enables efficient visits to visit destinations.

### Solution to Problem

To achieve the object described above, a visit-time-determining device according to an embodiment of the present invention is a visit-time-determining device that determines a visit time for a plurality of visit destinations, and includes a visit time determination unit configured to determine a visit time for each of the visit destinations, a clustering unit configured to cluster visit destinations on the basis of geographical positions of the visit destinations at each of the visit times determined by the visit time determination unit, and a re-determination visit destination selection unit configured to select a visit destination for which the visit time is to be re-determined from the plurality of visit destinations on the basis of a result of the clustering by the clustering unit, in which the visit time determination unit re-determines the visit time of the visit destination selected by the re-determination visit destination selection unit from times other than the determined visit time.

The visit-time-determining device according to the embodiment of the present invention determines the visit time of a visit destination, and then re-determines the visit time according to a result of clustering based on a geographical position of the visit destination. For example, after the visit time is determined in consideration of a possibility of a resident being at home, the visit time is re-determined in consideration of a position of the visit destination. Therefore, according to the visit-time-determining device according to the embodiment of the present invention, it is possible to enable efficient visits to the visit destinations.

### Advantageous Effects of Invention

According to an embodiment of the present invention, it is possible to enable efficient visits to visit destinations according to re-determination of a visit time.

### BRIEF DESCRIPTION OF DRAWINGS

FIG. 1 is a diagram which shows a configuration of a visit-time-determining device according to an embodiment of the present invention.

FIG. 2 is a diagram which shows information related to prediction of whether a resident is at home.

FIG. 3 is a diagram which schematically shows clustering of visit destinations.

FIG. 4 is a flowchart which shows processing executed by the visit-time-determining device according to the embodiment of the present invention.

FIG. 5 is a diagram which shows a hardware configuration of the visit-time-determining device according to the embodiment of the present invention.

### DESCRIPTION OF EMBODIMENTS

Hereinafter, an embodiment of a visit-time-determining device according to the present invention will be described in detail with reference to the drawings. Note that the same elements will be denoted by the same reference numerals and duplicated description will be omitted in the description of the drawings.

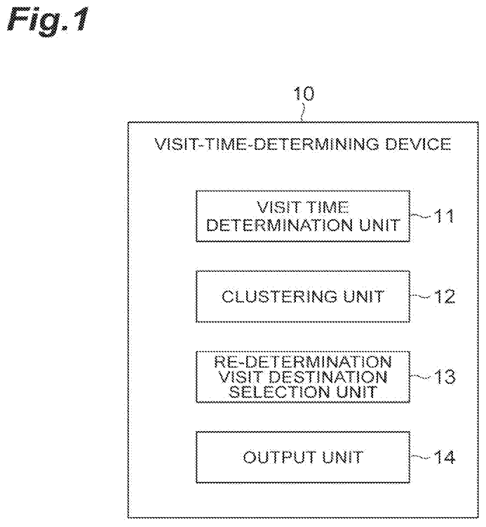

FIG. 1 shows a visit-time-determining device 10 according to the present embodiment. The visit-time-determining device 10 is a device (a system) that determines visit times (visit timings) for a plurality of visit destinations. Specifically, the visit-time-determining device 10 determines, as a visit time, a visit time (a delivery time, a delivery timing) at which a delivery company delivers goods to a visit destination (a delivery destination). When the goods are delivered, a resident of the visit destination needs to be at home. For this reason, the visit-time-determining device 10 determines a visit time by predicting whether the resident of the visit destination is at home. The visit-time-determining device 10 determines, for example, in which time period in units of hours to deliver each item in units of days (a day of delivery). In addition, the visit-time-determining device 10 may determine in which order to visit the visit destinations in units of hours.

The visit-time-determining device 10 may perform, for example, the determination of a visit time in units of business offices, or the like. That is, a set of visit destinations for which visit times are to be determined may be, for example, included in a delivery (visit) area handled by one business office. The delivery area is a geographical area set in advance, and is, specifically, a city block, a parcel, a standard region mesh cell, or the like.

Next, functions of the visit-time-determining device 10 according to the present embodiment will be described. As shown in FIG. 1, the visit-time-determining device 10 is configured to include a visit time determination unit 11, a clustering unit 12, a re-determination visit destination selection unit 13, and an output unit 14.

The visit time determination unit 11 is a functional unit that determines a visit time for each visit destination. The visit time determination unit 11 performs prediction of whether the resident of a visit destination is at home for each visit destination and time, and determines a visit time for each visit destination on the basis of a result of the prediction.

In the visit-time-determining device 10, a visit time for each visit destination may be re-determined (determined in stages). Specifically, the visit time determination unit 11 first determines visit times for all visit destinations. Thereafter, the clustering unit 12 and the re-determination visit destination selection unit 13 select a visit destination for which the visit time is to be re-determined (however, the visit destination may not be selected). For the selected visit destination, the visit time determination unit 11 determines the visit time again. After that, selection of a visit destination for which the visit time is to be re-determined and determination of the visit time for the visit destination are repeated until there is no selected visit destination.

The visit time determination unit 11 first determines visit times for all visit destinations as follows. The determined visit times are times in units of hours (the 8 o'clock hour, the 9 o'clock hour, and so forth) in a time period for delivery. However, it is not always necessary to use units of hours, and an arbitrary unit such as units of a number of minutes (for example, units of five minutes, units of ten minutes) may be used. The visit time determination unit 11 acquires information on a visit destination used for the prediction of whether the resident of the visit destination is at home for each of the plurality of visit destinations for which the visit times are to be determined (for which there are goods to be delivered). The visit time determination unit 11 performs the prediction of whether the resident of a visit destination is at home using the acquired information by using a prediction model (a classification model, a classifier) stored in advance.

For example, the visit time determination unit 11 calculates a home score, which is a value indicating a probability that a resident of a visit destination is at home every hour (for example, the 8 o'clock hour, the 9 o'clock hour, and so forth) in a similar manner to the determined visit time using the prediction model.

The information on a visit destination (the information input to the prediction model) includes information for each visit destination. For example, a rate at which a resident has been at home when a visit destination has been visited in the past may also be used as the information. In addition, the information may be information for each time, and past information on the same time of the day (the 8 o'clock hour, the 9 o'clock hour) as a time to be predicted is acquired as the information used for the prediction.

In addition, the information on a visit destination may include information on a geographical area in which the visit destination is positioned, in addition to the information for each visit destination. The geographical area is set in advance. For example, each mesh cell (for example, a standard region mesh cell) obtained by dividing the area to be predicted into a rectangle having one side that is about several hundred meters is assumed as the area described above. In the following description, an area is described as a mesh cell. However, an area does not necessarily have to be a mesh cell. By using information of a mesh cell, it is possible to predict whether a resident is at home even for a visit destination for which there is no information on each visit destination.

As the information of a mesh cell, information indicating an in-area state of mobile communication terminals held by residents of the mesh cell may be used. The information indicating the in-area state is, for example, a rate (for example, a value of a percentage) of the number of mobile communication terminals under a base station (a mobile phone base station) positioned in the mesh cell (mobile communication terminals that perform wireless communication with the base station) to the number of the mobile communication terminals held by the residents of the mesh cell. The rate is a rate of the residents of the mesh cell in the mesh cell, that is, a rate of the residents (highly likely to be) at home. In addition, the rate may be a value for each generation (age) and sex. Moreover, the rate may be a value for each time (time period) (for example, every hour), and the information on a time to be predicted is acquired. Furthermore, the information may be information on a time to be predicted or may also be past information on the same time of the day (the 8 o'clock hour, the 9 o'clock hour, and so forth) (the same applies for information in accordance with a time below).

In addition, as the information on a mesh cell, information indicating the rate of the residents of the mesh cell being at home for each age may also be used. The information indicating the in-area state is, for example, the rate (for example, a value of a percentage) of the residents of the mesh cell being at home for each generation of every 10 years. In addition, the rate of the residents being at home may also be a value for each sex. Moreover, the rate of the residents being at home may also be a value for each time. The rate of the residents being at home described above can be calculated on the basis of, for example, a visit history at the time of delivery in the past and information on the residents of the visit destinations. As described above, the information on a mesh cell may be based on a domain log (the visit history in the example described above) that is information for each of various services (the delivery service in the example described above).

Note that the information used for the prediction of whether the resident of a visit destination is at home is not limited to that described above. For example, information indicating weather at each time in the mesh cell may be used as the information indicating the prediction of whether the resident of a visit destination is at home. In addition, the information may also include information that is not for each time, in addition to the information for each time.

The information described above may be prepared in advance by an administrator of the visit-time-determining device 10 on the basis of, for example, statistical information for each mesh cell, information measured for each mesh cell, or the like, and input to the visit-time-determining device 10. Alternatively, the information described above may be acquired in advance from a database managed in each individual domain. The visit time determination unit 11 stores, for example, each piece of the information for each time described above in association with a visit destination or a mesh cell.

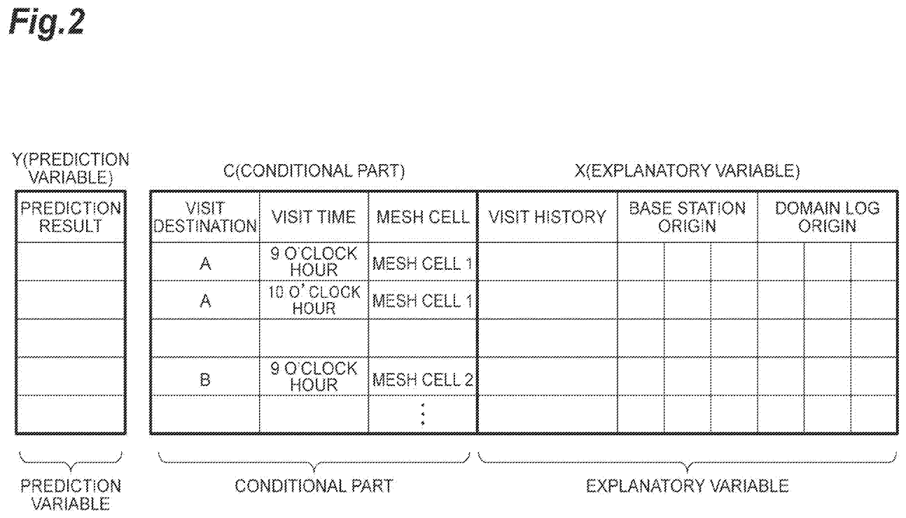

The visit time determination unit 11 acquires information indicating a visit destination for which the visit time is to be determined (that is, a visit destination for which there are goods to be delivered) by an input from the administrator or the like of the visit-time-determining device 10. The visit time determination unit 11 stores a mesh cell in which a visit destination is positioned for each visit destination in advance, and identifies the mesh cell in which a visit destination indicated by the input information is positioned. The visit time determination unit 11 acquires information stored in association with the visit destination or the mesh cell for each time for all delivery times (the 8 o'clock hour, the 9 o'clock hour, and so forth). That is, information (explanatory variables) X used for prediction is acquired from information (a conditional part) C of a visit destination, a visit time, and a mesh cell as shown in FIG. 2.

The visit time determination unit 11 inputs the information (explanatory variables) X used for prediction for each time to a prediction model and obtains a prediction result (prediction variables) Y for each time at each visit destination as shown in FIG. 2. The prediction result Y is a home score. The home score is, for example, a numerical value of 0 to 1, and a higher numerical value indicates a higher possibility of a resident of a visit destination being at home.

For example, the prediction model is generated by machine learning (supervised learning) based on machine learning information (teacher data, correct answer data) corresponding to the information (explanatory variables) X used for prediction for each time described above and the prediction result (prediction variables) Y. The machine learning information corresponding to the prediction result (prediction variables) Y is information such as “1” if the resident of a visit destination is at home, or “0” if the resident of a visit destination is not at home.

As the prediction model, any conventional model can be used. For example, a logistic regression model, a determination tree model, or a model based on a random forest, a gradient boosting determination tree, or a neural network can be used. In addition, the information used for prediction (explanatory variables) may be dimensionally compressed and input to the prediction model. Moreover, other methods may also be used to predict whether the resident of a visit destination is at home for each time.

The visit time determination unit 11 determines a visit time for each visit destination based on a home score for each visit destination and time. That is, the visit time determination unit 11 determines in which time period to visit each visit destination. The visit time determination unit 11 determines a visit time for each visit destination according to, for example, an optimization method. Specifically, the visit time for each visit destination is determined by solving an integer programming problem as follows. A variable that takes a value of 0 or 1 is set for each visit destination and time. If a variable is 1, this indicates that a visit destination corresponding to the variable is visited at a time corresponding to the variable. If a variable is 0, this indicates that a visit destination corresponding to the variable is not visited at a time corresponding to the variable.

A sum of products of a variable and a home score of a visit destination and a time corresponding to the variable for all visit destinations and times is set as an objective function, and a value of the objective function is maximized. The maximization of the objective function is to maximize the home score when (at a time at which) the visit destination is visited.

Conditions when the objective function is maximized are as follows. For each visit destination, a sum of variables at all times is set to 1. The conditions indicate that each visit destination is visited only at any one time. In addition, at each time, the sum of variables for all visit destinations is set to be equal to or less than a threshold value set in advance. The threshold value defines an upper limit of the number of visit destinations that can be visited per time (unit time) of a visit time period, and is a value in accordance with, for example, a skill of a visitor (a delivery person). The threshold value may be statistically determined based on, for example, the number of visits per unit time at the time of visits in the past. The threshold value may be set uniformly regardless of time, or may be changed in accordance with a time. In addition, when a visitor changes depending on a visit date and a delivery time, the threshold value may be a value in accordance with a visitor for each visit date and delivery time. For example, a distribution of the number of visits per unit time in the past for the visitor may be calculated to set a third quartile+1.5×(an interquartile range) as the threshold value.

The visit time determination unit 11 notifies the clustering unit 12 of the determined visit time for each visit destination. Note that the determination of a visit time may also be performed using a method other than the method described above.

The clustering unit 12 is a functional unit that clusters visit destinations on the basis of geographical positions of the visit destinations for each of the visit times determined by the visit time determination unit 11.

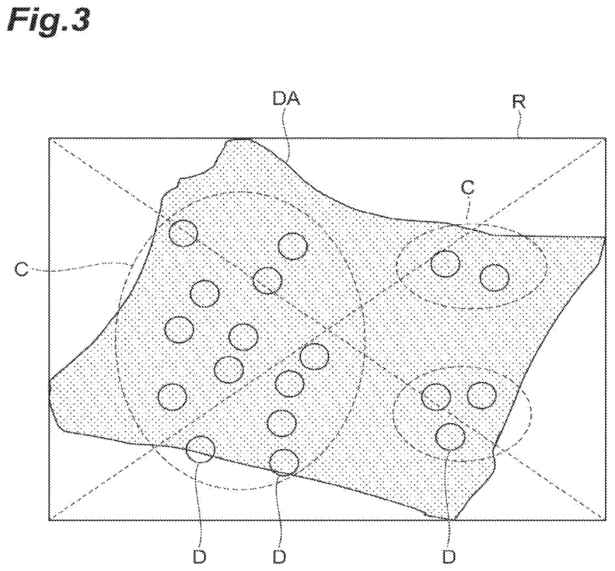

The clustering unit 12 stores the geographical position of each visit destination in advance. The geographical position is information indicating, for example, coordinates such as latitude and longitude. The clustering unit 12 receives the notification of the visit time for each visit destination from the visit time determination unit 11. The clustering unit 12 performs clustering (special clustering) on visit destinations on the basis of the geographical positions of the visit destinations at each visit time (for example, the 8 o'clock hour, the 9 o'clock hour, and so forth). Clustering can be performed in any conventional method, for example, a k-means method. According to this clustering, clusters of visit destinations for each visit time can be made. According to this clustering, for example, as shown in FIG. 3, visit destinations D determined to be visited at the same visit time in a delivery area DA belong to any one of a plurality of clusters C. The clustering unit 12 notifies the re-determination visit destination selection unit 13 of a result of the clustering.

The re-determination visit destination selection unit 13 is a functional unit that selects a visit destination for which the visit time is to be re-determined from a plurality of visit destinations on the basis of the result of the clustering performed by the clustering unit 12. The re-determination visit destination selection unit 13 selects a visit destination for which the visit time is to be re-determined on the basis of at least one of the number of visit destinations belonging to a clustered cluster and a spatial size of the cluster.

For the visit time determined as described above by the visit time determination unit 11, the geographical position of the visit destination is not considered. For this reason, visit destinations to which the same visit time (time period) is allocated are not necessarily geographically concentrated. For this reason, if visits to these visit destinations are made at the same visit time, there is a possibility that a moving distance may increase. The re-determination visit destination selection unit 13 selects a visit destination for which it is not appropriate to visit at the same visit time in consideration of this point as a visit destination for which the visit time is to be re-determined. That is, the re-determination visit destination selection unit 13 excludes remote visit destinations.

The re-determination visit destination selection unit 13 selects a visit destination for which the visit time is to be re-determined as follows for each visit time. The re-determination visit destination selection unit 13 compares the number of visit destinations of a cluster to which the most visit destinations belong with a threshold value set in advance, and determines whether the number of visit destinations is equal to or less than the threshold value. This threshold value is used to select a visit destination for which the visit time is to be re-determined, and is set to a value slightly smaller than a threshold value when the visit time determination unit 11 determines a visit destination. In addition, this threshold value may have a predetermined rate less than 1 with respect to the threshold value when the visit time determination unit 11 determines a visit destination. Note that this threshold value may be set as an upper limit of the number of visit destinations that can be visited per unit time, and the threshold value when the visit time determination unit 11 determines a visit destination may also be set as a value larger than this threshold value. Moreover, this threshold value may be set as a value according to a time and a visitor as described above.

When it is determined that the number of visit destinations is not equal to or less than the threshold value (the number of visit destinations exceeds the threshold value), the re-determination visit destination selection unit 13 selects a visit destination other than the visit destinations of a cluster to which the most visit destinations belong as a visit destination for which the visit time is to be re-determined. On the other hand, when it is determined that the number of visit destinations is equal to or less than the threshold value, the re-determination visit destination selection unit 13 integrates the cluster to which the most visit destinations belong and a cluster at a position closest to the cluster to create a new cluster. A distance between the clusters is, for example, a distance between positions of centers of gravity of the clusters, which are centers of gravity of visit destinations belonging to the clusters.

The re-determination visit destination selection unit 13 compares the number of visit destinations of the integrated cluster with the threshold value described above, and determines whether the number of visit destinations is equal to or less than the threshold value. When it is determined that the number of visit destinations is not equal to or less than the threshold value (the number of visit destinations exceeds the threshold value), the re-determination visit destination selection unit 13 selects a visit destination other than the visit destinations of the cluster to which the most visit destinations belong before the integration as a visit destination for which the visit time is to be re-determined. On the other hand, when it is determined that the number of visit destinations is equal to or less than the threshold value, the re-determination visit destination selection unit 13 sets the integrated cluster as the cluster to which the most visit destinations belong, and repeats the integration of clusters and the determination using the threshold value described above.

In addition, the re-determination visit destination selection unit 13 may select a visit destination for which the visit time is to be re-determined as follows in addition to the method described above or instead of the method described above. The re-determination visit destination selection unit 13 generates, for example, a smallest rectangle R circumscribed about the delivery area DA as shown in FIG. 3. Note that each side of the rectangle R is set to be parallel to directions set in advance (for example, latitude and longitude). A half of a diagonal of this rectangle is set to dmax. Note that dmax may be calculated for each delivery area DA in advance. The re-determination visit destination selection unit 13 calculates a sum d of squares of a distance between a center of gravity of a cluster to which the most visit destinations belong and positions of visit destinations belonging to the cluster. The re-determination visit destination selection unit 13 calculates d/dmax as a value indicating a spatial size of the cluster.

The re-determination visit destination selection unit 13 compares d/dmax with a threshold value set in advance, and determines whether d/dmax is equal to or less than the threshold value. This threshold value is an upper limit of a delivery range to be delivered per unit time, and is a value in accordance with, for example, the skill of a visitor (a delivery person). This threshold value may be statistically determined based on, for example, a visit range per unit time at the time of visits in the past. This threshold value is a value of 1 or less, and is, for example, 0.5. In addition, this threshold value may be a value in accordance with a time and a visitor as described above. Moreover, this threshold value may also be a value in accordance with the number of visit destinations included in the cluster. When the number of visit destinations is small, it is considered that there is an energy to spend travel cost (visit destinations of a wide range can be visited). Therefore, as the number of visit destinations included in a cluster decreases, the threshold value may be set to a larger number.

When it is determined that d/dmax is not equal to or less than the threshold value (d/dmax exceeds the threshold value), the re-determination visit destination selection unit 13 selects a visit destination other than the visit destinations of the cluster to which the most visit destinations belong as a visit destination for which the visit time is to be re-determined. On the other hand, when it is determined that d/dmax is equal to or less than the threshold value, the re-determination visit destination selection unit 13 integrates the cluster to which the most visit destinations belong and a cluster closest to the cluster to create a new cluster.

The re-determination visit destination selection unit 13 calculates d/dmax for the integrated cluster, compares the calculated d/dmax with the threshold value described above, and determines whether d/dmax is equal to or less than the threshold value. When it is determined that d/dmax is not equal to or less than the threshold value (d/dmax exceeds the threshold value), the re-determination visit destination selection unit 13 selects a visit destination other than the visit destinations of the cluster to which the most visit destinations belong before the integration as a visit destination for which the visit time is to be re-determined. On the other hand, when it is determined that d/dmax is equal to or less than the threshold value, the re-determination visit destination selection unit 13 sets the integrated cluster as the cluster to which the most visit destinations belong, and repeats the integration of clusters described above and the determination using the threshold value.

In addition, when it is determined that d/dmax is not equal to or less than the threshold value (d/dmax exceeds the threshold value), the re-determination visit destination selection unit 13 may select a visit destination of the cluster to which the most visit destinations belong as the visit destination for which the visit time is to be re-determined in order of decreasing distance from a center of gravity of the cluster, and exclude it from the cluster until d/dmax is equal to or less than the threshold value.

The re-determination visit destination selection unit 13 notifies the visit time determination unit 11 of the selected visit destination. Note that the selection of a visit destination may be performed by any method other than the method described above as long as the result of the clustering is used.

The visit time determination unit 11 re-determines the visit time of the visit destination selected by the re-determination visit destination selection unit 13 from times other than the determined visit time. The visit time determination unit 11 receives the notification of the selected visit destination from the re-determination visit destination selection unit 13. The visit time determination unit 11 determines the visit time of the selected visit destination by solving the integer programming problem described above. In this case, variables of visit destinations that are not selected (visit destinations for which the visit times are not re-determined) are set to values that have already been determined. For variables of the selected visit destination (the visit destination for which the visit time is to be re-determined), a variable that has been set to 1 among the values that have already been determined is set to 0, and the other variables are set as determination targets. By solving the integer programming problem according to this setting, for the selected visit destination, a variable of a new time is 1, and a new visit time can be determined.

A visit destination for which the visit time is to be re-determined is selected again on the basis of a determined visit time for each visit destination in the same manner as described above. The visit time determination unit 11, the clustering unit 12, and the re-determination visit destination selection unit 13 repeat the determination of a visit time and the selection of a visit destination for which the visit time is to be re-determined until a visit destination for which the visit time is to be re-determined is not selected any longer. If a visit destination for which the visit time is to be re-determined is not selected, the visit time determination unit 11 outputs information indicating the determined visit time to the output unit 14.

The visit time determination unit 11 may determine a visit order for a plurality of visit destinations with visit times set to the same time (time period). For example, the visit time determination unit 11 may also determine the visit order in consideration of a moving distance by solving a traveling salesman problem (a combined optimization problem) on the basis of a geographical position of each visit destination. The traveling salesman problem can be solved by any conventional method, for example, an exact solution method, an approximate solution method, or a metaheuristic.

In addition, a visit time may also be re-determined through a method other than that described above. For example, a visit time at which a position of the selected visit destination falls within an area of a cluster (for example, a predetermined distance from the center of gravity of the cluster) at each visit time different from the visit time before the re-determination may also be set and adopted as a new visit time. Moreover, when the visit time is re-determined, a visit time at which a visit destination to be visited has not been visited may be prioritized. Since learning data for generating a prediction model according to machine learning can be collected by allocating the visit time with no visit history thereto, high accuracy of a prediction model can be achieved.

The output unit 14 is a functional unit that outputs information indicating a visit time for each of the plurality of visit destinations, which is determined by the visit time determination unit 11. The output unit 14 inputs the information indicating a visit time for each visit destination from the visit time determination unit 11. The output unit 14 displays and outputs, for example, the information on a display device included in the visit-time-determining device 10. The information is referred to by the administrator or the like of the visit-time-determining device 10 according to the output and used for the delivery. Alternatively, the output unit 14 may also perform an output other than the display, and may also transmit and output the information to another device, another module, or the like. The above is a function of the visit-time-determining device 10 according to the present embodiment.

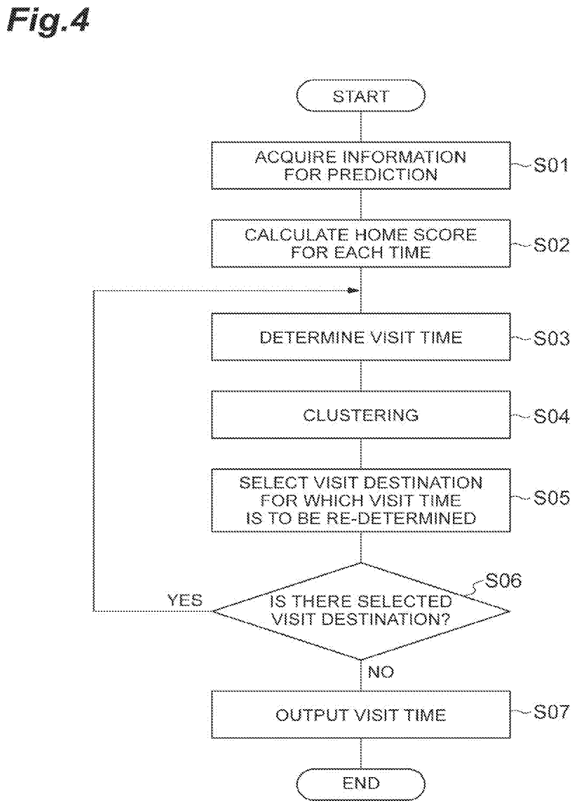

Next, the processing executed by the visit-time-determining device 10 according to the present embodiment (an operation method performed by the visit-time-determining device 10) will be described using a flowchart of FIG. 4. In the processing, first, the information indicating a plurality of visit destinations for which the visit times are to be determined is input and information related to a visit destination used for the prediction of whether the resident of the visit destination is at home is acquired by the visit time determination unit 11 (S01). Subsequently, the visit time determination unit 11 calculates a home score for each time for all the visit destinations based on the information (S02). Then, the visit time determination unit 11 determines the visit time for each visit destination based on the home score for each visit destination and each time (S03).

Next, the clustering unit 12 clusters visit destinations on the basis of the geographical positions of the visit destinations for each visit time (S04). Subsequently, the re-determination visit destination selection unit 13 selects a visit destination for which the visit time is to be re-determined from the plurality of visit destinations on the basis of a result of the clustering (S05). When there is a selected visit destination (YES in S06), the visit time determination unit 11 re-determines the visit time for each selected visit destination (S03), and repeats subsequent processing (S04 to S06).

When there are no selected visit destinations (NO in S06), the output unit 15 outputs the information indicating the determined visit time for each visit destination (S07). The above is processing executed by the visit-time-determining device 10 according to the present embodiment.

In the present embodiment described above, the visit time is re-determined in accordance with the result of the clustering based on the geographical positions of a visit destination after the visit time of the visit destination is determined. Specifically, the visit time is re-determined in consideration of the position of a visit destination after the visit time is determined in consideration of a possibility that a resident thereof is at home. Therefore, it is possible to enable efficient visits to visit destinations according to the present embodiment. Specifically, it is possible to enable visits to visit destinations in consideration of both cost (a moving distance) and a visit completion rate (a task completion rate) of the visit at the same time. Note that it is difficult to determine a visit time in consideration of the cost and the visit completion rate of a visit at one time, and the visit time can be reliably and appropriately determined by re-determining the visit time as in the present embodiment.

Moreover, the visit time may also be determined by performing the prediction of whether the resident of a visit destination is at home as in the present embodiment. According to this configuration, the visit time can be reliably and appropriately determined in consideration of the visit completion rate. However, the visit time may also be determined on the basis of other than the result of the prediction of whether the resident of a visit destination is at home.

In addition, a visit destination for which the visit time is to be re-determined may also be selected on the basis of at least one of the number of visit destinations belonging to a clustered cluster and the spatial size of the cluster as in the present embodiment. According to this configuration, the visit destination can be appropriately selected, and, as a result, the visit time can be appropriately determined. However, according to the selection based on a result of the clustering, selection other than that described above may also be performed.

Note that a delivery time is determined as a determined visit time. However, the visit time determined in one embodiment of the present invention does not necessarily have to be a delivery time. That is, one embodiment of the present invention does not necessarily premised on the delivery of goods, and may also be premised on any situation as long as a visit time for a plurality of visit destinations are determined.

A block diagram used for the description of the embodiment described above shows blocks in units of function. These functional blocks (components) are realized by at least an arbitrary combination of hardware and software. In addition, a method of realizing each functional block is not particularly limited. That is, each functional block may be realized using one physically or logically coupled device, and may also connect two or more devices physically or logically separated directly or indirectly (for example, using a wired method, a wireless method, or the like) and realized using the plurality of these devices. The functional block may also be realized by combining software with the one device described above or the plurality of devices described above.

Functions include judging, deciding, determining, computing, calculating, processing, deriving, investigating, searching, confirming, receiving, transmitting, outputting, accessing, resolving, selecting, choosing, establishing, comparing, assuming, expecting, observing, broadcasting, notifying, communicating, forwarding, configuring, reconfiguring, allocating or mapping, assigning, and the like, but are not limited thereto. For example, a functional block (a component) that functions transmission is referred to as a transmitting unit or a transmitter. In any case, as described above, a realizing method thereof is not particularly limited.

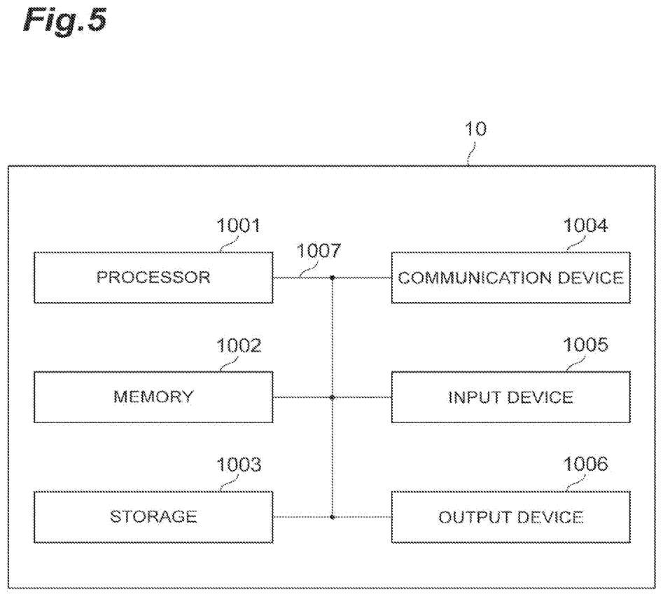

For example, the visit-time-determining device 10 according to the embodiment of this specification may function as a computer that performs processing of the method of this specification. FIG. 5 is a diagram which shows an example of a hardware configuration of the visit-time-determining device 10 according to the embodiment of this specification. The visit-time-determining device 10 described above may be physically configured as a computer device that includes a processor 1001, a memory 1002, a storage 1003, a communication device 1004, an input device 1005, an output device 1006, a bus 1007, and the like.

Note that the word of “device” can be read as a circuit, a device, a unit, or the like in the description above. A hardware configuration of the visit-time-determining device 10 may be configured to include one or a plurality of devices shown in FIG. 5, or may be configured not to include some devices.

Each function of the visit-time-determining device 10 is realized by the processor 1001 performing an arithmetic operation by causing predetermined software (a program) to be loaded on hardware such as the processor 1001 and the memory 1002 to control communication by the communication device 1004, or to control at least one of reading and writing of data in the memory 1002 and the storage 1003.

The processor 1001 causes, for example, an operating system to operate to control an entire computer. The processor 1001 may be configured by a central processing unit (CPU) that includes an interface with peripheral devices, a control device, an arithmetic operation device, a register, and the like. For example, each function of the visit-time-determining device 10 described above may also be realized by the processor 1001.

Moreover, the processor 1001 reads a program (a program code), a software module, data, and the like from at least one of the storage 1003 and the communication device 1004 into the memory 1002, and executes various types of processing according to these. As the program, a program that causes a computer to execute at least a part of the operations described in the embodiment described above is used. For example, each function of the visit-time-determining device 10 may be realized by a control program that is stored in the memory 1002 and operates in the processor 1001. Although it is described that the various types of processing described above are executed by one processor 1001, the various types of processing may also be executed simultaneously or sequentially by two or more processors 1001. The processor 1001 may be implemented by one or more chips. Note that the program may also be transmitted from a network via an electric communication line.

The memory 1002 is a computer-readable recording medium, and may be configured to include at least one of, for example, a read only memory (ROM), an erasable programmable ROM (EPROM), an electrically erasable programmable ROM (EEPROM), and a random access memory (RAM). The memory 1002 may also be referred to as a register, a cache, a main memory (a main memory device), or the like. The memory 1002 may store a program (a program code), a software module, or the like which can be executed for implementation of a method according to one embodiment of this specification.

The storage 1003 is a computer-readable recording medium, and may also be configured to include at least one of, for example, an optical disc such as a compact disc ROM (CD-ROM), a hard disk drive, a flexible disk, a magneto-optical disk (for example, a compact disc, a digital versatile disc, a blu-ray (registered trademark) disc), a smart card, a flash memory (for example, a card, a stick, a key drive), a floppy (registered trademark) disk, a magnetic strip, and the like. The storage 1003 may also be referred to as an auxiliary storage device. The storage medium described above may also be, for example, a database including at least one of the memory 1002 and the storage 1003, a server, or another appropriate medium.

The communication device 1004 is hardware (a transmission and reception device) for performing communication between computers via at least one of a wired network and a wireless network, and is also referred to as, for example, a network device, a network controller, a network card, a communication module, or the like. For example, each function of the visit-time-determining device 10 described above may also be realized by the communication device 1004.

The input device 1005 is an input device (for example, a keyboard, a mouse, a microphone, a switch, a button, a sensor, or the like) that receives an input from the outside. The output device 1006 is an output device (for example, a display, a speaker, an LED lamp, or the like) that implements an output to the outside. Note that the input device 1005 and the output device 1006 may be integrated (for example, a touch panel).

In addition, devices such as the processor 1001 and the memory 1002 are connected by the bus 1007 for communication of information. The bus 1007 may be configured using a single bus, and may also be configured using a different bus for each device.

Moreover, the visit-time-determining device 10 may be configured to include hardware such as a micro-processor, a digital signal processor (DSP), an application specific integrated circuit (ASIC), a programmable logic device (PLD), and a field programmable gate array (FPGA), and some or all of the functional blocks may be realized by the hardware. For example, the processor 1001 may be implemented using at least one of these pieces of hardware.

A method of notifying of information is not limited to those in the aspect or embodiment described in this specification, and the notification may be performed using another method.

The order of the processing sequences, the sequences, the flowcharts, and the like of the aspects/embodiments described above in this specification may be changed as long as it does not cause any inconsistencies. For example, in the methods described in this specification, various steps are described as elements in an exemplary order but the methods are not limited to the described order.

The input or output information or the like may be stored in a specific place (for example, a memory) or may be managed using a management table. The input or output information or the like may be overwritten, updated, or added. The output information or the like may be deleted. The input information or the like may be transmitted to another device.

Determination may be performed using a value (0 or 1) which is expressed in one bit, may be performed using a Boolean value (true or false), or may be performed by comparison of numerical values (for example, comparison with a predetermined value).

The aspects/embodiments described in this specification may be used alone, may be used in combination, or may be switched during implementation thereof. Transmission of predetermined information (for example, transmission of “X”) is not limited to explicit transmission, and may be performed by implicit transmission (for example, the predetermined information is not notified).

While the embodiments of the invention have been described above in detail, it is apparent to those skilled in the art that the invention is not limited to the embodiments described in this specification. The invention can be modified and altered in various forms without departing from the gist and scope of the invention defined by description in the appended claims. Accordingly, description in this specification is for exemplary explanation, and does not have any restrictive meaning for the present invention.

Regardless of whether it is called software, firmware, middleware, microcode, hardware description language, or another name, software can be widely interpreted to refer to commands, a command set, codes, code segments, program codes, a program, a sub program, a software module, an application, a software application, a software package, a routine, a sub routine, an object, an executable file, an execution thread, an order, a function, or the like.

Software, commands, information, and the like may be transmitted and received via a transmission medium. For example, when software is transmitted from a web site, a server, or another remote source using wired technology (such as a coaxial cable, an optical fiber cable, a twisted-pair wire, or a digital subscriber line (DSL)) and/or wireless technology (such as infrared rays, or microwaves), the wired technology and/or the wireless technology are included in the definition of the transmission medium.

Information, signals, and the like described in this specification may be expressed using one of various different techniques. For example, data, an instruction, a command, information, a signal, a bit, a symbol, and a chip which can be mentioned in the overall description may be expressed by a voltage, a current, an electromagnetic wave, a magnetic field or magnetic particles, a photo field or photons, or an arbitrary combination thereof.

The terms described in this specification and the terms required for understanding this specification may be substituted by terms having the same or similar meanings.

Information, parameters, and the like described in this specification may be expressed by absolute values, may be expressed by values relative to a predetermined value, or may be expressed by other corresponding information. For example, radio resources may be indicated by indices.

Names which are used for the above-mentioned parameters are not restrictive in any viewpoint. Expressions or the like using the parameters may be different from the expressions which are explicitly disclosed in this specification.

The term “determining” or “determination” which is used in this specification may include various types of operations. The term “determining” or “determination” may include, for example, cases in which judging, calculating, computing, processing, deriving, investigating, looking up, search, inquiry (for example, looking up in a table, a database, or another data structure), and ascertaining are considered to be “determined.” The term “determining” or “determination” may include cases in which receiving (for example, receiving information), transmitting (for example, transmitting information), input, output, and accessing (for example, accessing data in a memory) are considered to be “determined.” The term “determining” or “determination” may include cases in which resolving, selecting, choosing, establishing, comparing, and the like are considered to be “determined.” That is, the term “determining” or “determination” can include cases in which a certain operation is considered to be “determined.” In addition, “determination” may be replaced with “assuming,” “expecting,” “considering,” or the like.

The terms “connected” and “coupled” or any modifications thereof mean any direct or indirect connection or coupling between two or more elements, and can include that there are one or more intermediate elements between two elements that are “connected” or “coupled” to each other. The coupling or connection between elements may be physical one, a logical one, or a combination of these. For example, “connection” may be read as “access.” When used in this specification, two elements can be considered to be “connected” or “coupled” to each other using electromagnetic energy and the like with wavelengths in a radio frequency area, a microwave area, and a light (both visible and invisible light) area as some non-limiting and non-exhaustive examples using at least one of one or more wires, cables, and printed electrical connections.

The expression “on the basis of” as used in this specification does not mean “on the basis of only” unless otherwise described. In other words, the expression “on the basis of” means both “on the basis of only” and “on the basis of at least.”

When the terms “include,” “including,” and modifications thereof are used in this specification, the terms are intended to have a comprehensive meaning similar to the term “comprising.” The term “or” which is used in this specification is not intended to mean an exclusive logical sum.

In this specification, when articles are added by translation, for example, a, an, and the in English, this specification may include that nouns following these articles are plural.

In this specification, the term “A and B are different” may man that “A and B are different from each other. Note that the term may mean that “A and B are different from C.” The terms such as “separate” and “coupled” may be translated similarly to “different.”

### REFERENCE SIGNS LIST

10 Visit-time-determining device
11 Visit time determination unit
12 Clustering unit
13 Re-determination visit destination selection unit
14 Output unit
1001 Processor
1002 Memory
1003 Storage
1004 Communication device
1005 Input device
1006 Output device
1007 Bus

1: A visit-time-determining device that determines a visit time for a plurality of visit destinations comprising circuitry configured to:
determine a visit time for each of the visit destinations;
cluster visit destinations on the basis of geographical positions of the visit destinations at each of the determined visit times; and
select a visit destination for which the visit time is to be re-determined from the plurality of visit destinations on the basis of a result of the clustering,
wherein the circuitry re-determines the visit time of the selected visit destination from times other than the determined visit time.

2: The visit-time-determining device according to claim 1, wherein the circuitry performs a prediction of whether a resident of a visit destination is at home for each visit destination and time, and determines a visit time for each of the visit destinations on the basis of a result of the prediction.

3: The visit-time-determining device according to claim 1, wherein the circuitry selects a visit destination for which the visit time is to be re-determined on the basis of at least one of the number of visit destinations belonging to a clustering cluster and a spatial size of the cluster.

4: The visit-time-determining device according to claim 2, wherein the circuitry selects a visit destination for which the visit time is to be re-determined on the basis of at least one of the number of visit destinations belonging to a clustering cluster and a spatial size of the cluster.
